(19) United States
(12) Patent Application Publication
(10) Pub. No.: US 2024/0245084 A1
(43) Pub. Date: Jul. 25, 2024

(54) MEDICAL FOOD TREATMENT FOR FOOD ALLERGIES

(71) Applicant: Thomas Paul Miller, Grand Rapids, MI (US)

(72) Inventor: Thomas Paul Miller, Grand Rapids, MI (US)

(21) Appl. No.: 18/422,993

(22) Filed: Jan. 25, 2024

Related U.S. Application Data
(60) Provisional application No. 63/441,168, filed on Jan. 25, 2023.

(51) Int. Cl. A23L 25/00; A23L 29/30; A23L 33/00

(52) U.S. Cl. CPC A23L 25/30; A23L 29/30; A23L 33/40

(57) ABSTRACT

A method of treating allergies and desensitizing individual persons to an allergy to a specific food, using rapid desensitization days spaced apart, followed by daily dosages for multiple weeks.

### CROSS-REFERENCE TO RELATED APPLICATIONS

This application claims the benefit of U.S. Provisional Application Ser. No. 63/441,168, filed Jan. 25, 2023, which is incorporated herein by reference in its entirety.

### FIELD OF THE INVENTION

The present invention relates to the field of food allergies in humans and method of managing same, using medical foods, not pharmaceutical agents and a method of manufacturing the food products including the allergens.

### BACKGROUND OF THE INVENTION

There remains a need for a medical food with specific known allergens for use with a method for treatment and the management of food allergies. A medical food option would allow greater access to life-saving therapies and at a reduced cost compared to a pharmaceutical agent.

Oral immunotherapy for the management of food allergies is currently most commonly done utilizing one of two methods. The first method is based on the work of Dr. Richard Wasserman and others, while the second utilizes the FDA approved product Palforzia. The Wasserman method involves the mixing of various nut flours or nut milks with water. As the concentration of the nut increases individuals are switched to portions of nuts with subsequent doses being the nuts themselves. Some pharmacists have mixed peanut flour with LoxOral, which is an excipient capsule base, for the purposes of formulating a dry powder therapeutic agent that could be consumed orally for the purposes of oral desensitization for food allergies. The use of LoxOral, which is a pharmaceutical and not a food, negates the product from being considered a medical food. While keeping the nut flours in their dry form greatly increases shelf life and may allow for more uniform dosing, the use of a pharmacist and pharmaceutical ingredients, and nonfood components substantially raises the cost and also limits the availability of the treatment broadly to patients.

With regard to the above treatment, Dr. Wasserman and colleagues published their experience treating peanut allergy patients (Wasserman R L, et al. Real-World Experience with Peanut Oral Immunotherapy: Lessons Learned From 270 Patients. J Allergy Clin Immunol Pract 2019; 7:418-26). They reported observations of 270 peanut allergic patients undergoing oral immunotherapy from Jan. 1, 2009 until Jun. 1, 2017. Of the 270 patients 214 (79%) completed immunotherapy escalation to a target dose. The target dose was 3000 mg peanut protein in 211 patients, of whom 210 passed a 6000 mg oral challenge. Three patients reached a reduced target dose of 2000 mg.

The second method of oral immunotherapy for the treatment of food allergies employed involves the use of the FDA approved biologic pharmaceutical agent Palforzia for the treatment of peanut allergy. The largest preapproval trial was published recently (AR101 Oral Immunotherapy for Peanut Allergy. N Engl J Med 2018; 379:1991-2001). Of the 273 participants who received active treatment 250 (67.2%) were able to tolerate a ≥600 mg oral challenge dose. Fifty percent tolerated a 1000 mg oral challenge dose.

Both of these methods employed a multi-dose escalation first day and then weekly or every other week dose escalations to reach a target dose. The Wasserman protocol day 1 escalation starts at 1-2 micrograms (0.001-0.002 mg) of peanut protein with a goal of 2-10 mg peanut protein for that first day. His more recent protocols went from 2 micrograms to 2 mgs on the first day. Palforzia also has a single multi-dose first day going from 0.5 mg-6 mg. Again this second method uses a pharmaceutical ingredient causing the same issues as with the first or Wasserman methods or protocols.

The total escalation target dose is 3000 mg for Wasserman protocols and 300 mg for Palforzia. After achieving the target dose patients completing the Wasserman protocols are considered desensitized to peanut and may incorporate any peanut product that they desire into their diet. With Palforzia patients are not considered desensitized, must continue reading labels and continue to avoid peanut products. The Wasserman method calls for 3 years of maintenance with 8 peanuts a day, whereas the Palforzia approval calls for lifelong maintenance on Palforzia. The cost difference is staggering, as Palforzia costs at least $890 per month.

As stated above, the use of pharmaceutical agents and ingredients raise cost and limits the broad use of any of these methods or protocols.

### SUMMARY OF THE INVENTION

To overcome the specific limitations mentioned above, as well as create an overall improved and more cost effective method, the present invention uses a medical food incorporating a specific amount of allergenic medical treatment food, orally consumed for the purpose of desensitizing an individual person who has an allergy to a particular food. These medical foods are consumer products, readily available, and are not and do not include pharmaceutical agents. Pharmaceutical agents typically means any active or inactive drug, biologic, reagent, or similar which is approved, conditionally approved or indexed by the Food and Drug Administration. In comparison, more information on what qualifies as a medical food may be found at https://www.fda.gov/regulatory-information/search-fda-guidance-documents/guidance-industry-frequently-asked-questions-about-medical-foods-second-edition The present invention incorporates medical food into the diet of the allergic individual in a precise manner, under medical supervision, more specifically, in an increasing manner, resulting in the development of a certain degree of immunologic and clinical tolerance to the specific food allergy by the individual. These medical foods are prepared either by mixing variable amounts of the allergenic food product, such as a commercially available nut flour, nut milk, or other liquid, with water, another commercially available liquid, or a commercially available consumable dry good such as a powder or flour. This method is distinct from and does not use any pharmaceutical agent that might be used for a similar purpose in that the individual who has the specific nutritional requirement of complete avoidance of the specific allergenic food undergoes the dietary management of the food allergy condition by incorporating the medical food into their diet in a controlled, specific, supervised way.

The present invention includes developing a dry powder form of oral immunotherapy utilizing a medical food, including a commercially available known allergenic food product, mixed with another commonly available food product to make dilutions of the allergenic food, for the management of food allergies. The protocol or method of treatment for the current invention also has important differences from the prior two methods not only in ingredients but also in the method of treatment. As compared to the prior methods, instead of a single multi-dose first day, the present invention protocol utilizes 3 multi-dose days 1 week apart. The starting doses are lower with a more gradual increase initially. For example, for a peanut allergy, the first multi-dose escalation goes from 0.137 micrograms (0.000137 mg) peanut protein to 0.0137 mg. The second multi-dose day goes from 0.0274 mg to 0.137 mg. The third and final multi-dose day goes from 0.274 mg to 1.37 mg peanut protein. From that point the escalation continues and reaches a target dose of 3000 mg peanut protein in approximately 20 weeks, followed by a 6000 mg oral challenge. Starting at a lower dose and escalating more slowly initially has surprisingly been found to have significant advantages as compared to the prior teachings. Of the first 50 patients treated for peanut allergy using the method of treatment of the present invention 46 patients or 92% of the test group achieved a target dose of 3000 mg peanut protein and passed a 6000 mg oral challenge. These patient's peanut allergy severity before treatment was at least as bad as the Wasserman subjects (average pretreatment peanut specific IgE level 52.1 compared to 41.9 from the Wasserman subjects in those with follow up data). In addition, these patients had more severe food allergies in general and the protocols were more challenging in that 22 of the 50 were multi-food allergic and the peanut treatment was just part of a multi-food desensitization protocol.

Peanut only treatment made up the other 28 patients. At the end of treatment using the present invention method of treatment, patients are considered fully desensitized to peanut. The method of treatment then has then maintaining this desensitized state by consuming 8 peanuts a day. They may incorporate any peanut product that they desire and will continue daily maintenance for at least 3 years.

The present invention is directed to a method desensitizing a patient to a specific target food allergy using a medical food free of pharmaceutical agents, said method comprising preparing a medical food product through the following steps: (1) providing a food product that is non-reactive for the specific target allergy; (2) preparing an allergy treatment powder, from a base material that is non-reactive for the specific target allergy and an allergen material, wherein the specific concentration of the allergen material in said allergy treatment is known; and (3) mixing specified amounts of said allergy treatment powder with said food product to create a plurality of medical food products, each with a different dosage amount.

Then conducting a first rapid desensitization day (RDD1) through the following steps: (1) treating the patient through the patient ingesting multiple times and at specified spaced apart time intervals said medical food products and wherein the majority of said medical food ingested at spaced apart intervals has different dosage amounts; and (2) monitoring the patient for adverse reactions. The patient will then ingest said medical food product having a known concentration each day for a first time period, typically about a week and then conducting at the end of the first time period a second rapid desensitization day (RDD2) through the following steps: (1) treating the patient through the patient ingesting multiple times and at specified spaced apart time intervals said medical food products and wherein the majority of said medical food ingested at spaced apart intervals has different dosage amounts; and (2) monitoring the patient for adverse reactions. The patient will then ingest said medical food product having a known concentration each day for a second time period and continuing treatment of administering said medical food each day using a medical food of specified dosage, and increasing in dosage in the medical food ingested in regular time intervals. Then continuing treatment by directly ingesting each day the allergy inducing food for the specific allergy in place of the medical food, and increasing the amounts of allergy inducing food ingested in regular time intervals; and maintaining an ongoing treatment protocol through ingestion at specified intervals.

The method of further includes a step of preparing an allergy treatment powder further includes the step of creating multiple allergy treatment powders having different concentrations of said allergen materials. This may be accomplished through serial dilution with a base material that is non-reactive for the specific target food allergy. The different dosage amounts during said RDD1 and RDD2 are increasing dosage amounts, with the last dose on said RDD1 includes at least 100 times more of the specific allergen than said first dose on said RDD1. The second dose includes 2-4 times more of the specific allergen than said first dose, and said third includes 5-10 times more, said fourth dose includes 10-30 times more, said fifth dose includes 30-80 times more and said last dose includes at least 100 times more. More preferably, said second dose includes 3 times, said third dose includes 8 times, said fourth dose includes 20 times, said fifth dose includes 50 times and said sixth dose includes 100 times.

In comparison, for RDD2, the last dose on said RDD2 includes 3-6 times more of the specific allergen than said first dose on said RDD2, more preferably, the last dose on said RDD2 includes 5 times more allergen than said first dose. In addition, the first dose on RDD2 includes at least 2 times more allergen than said last dose on said RDD2.

The method also preferably includes a third rapid desensitization day (RDD3), and the last dose on said RDD3 includes 3-6 times more of the specific allergen than said first dose on said RDD3. The interval between said RDD1 and RDD2, and said RDD2 an RDD3 is a week. The step of continuing treatment of administering said medical food each day using a medical food of specified dosage lasts for at least five weeks, preferably at least eight weeks, more preferably ten weeks, and typically less than thirteen weeks. After RDD3, and after the above step of continuing treatment of administering said medical food each day using a medical food of specified dosage, then the step of continuing treatment by directly ingesting each day the allergy inducing food for the specific allergy in place of the medical food, lasts for at least eight weeks. More preferably, the method then continues by directly ingesting each day the allergy inducing food lasts for at least ten weeks. For example, if the specific target food allergy is a nut allergy and wherein for at least two weeks following the completion of treatment using a medical food the patient will daily ingest a flour made from the nut and for the remaining weekly period directly ingest at least one nut to which the patient is allergic. After treatment, the patient enters a maintenance phase by maintaining an ongoing treatment protocol including daily ingesting of the specific allergenic food.

The present invention also is directed to a method desensitizing a patient to a specific target allergy using a medical food free of pharmaceutical agents, said method comprising: preparing a medical food product through the following steps: (1) providing a food product that is non-reactive for the specific target allergy; (2) preparing an allergy treatment powder, from a base material that in non-reactive for the specific target allergy and an allergen material, wherein the specific concentration of the allergen material in said allergy treatment is known; and (3) mixing specified amounts of said allergy treatment powder with said food product to create a plurality of medical food products, each with a different dosage amount; then conducting a first rapid desensitization day (RDD1) through the following steps: (A) treating the patient through the patient ingesting multiple times and at specified spaced apart time intervals said medical food products and wherein the majority of said medical food ingested at spaced apart intervals is in increasing dosage amounts; and (B) monitoring the patient for adverse reactions. After RDD1, the patient ingests said medical food product having a known concentration each day for a first time period, and then the end of the first time period a second rapid desensitization day (RDD2) through the following steps is performed (1) treating the patient through the patient ingesting multiple times and at specified spaced apart time intervals said medical food products and wherein the majority of said medical food ingested at spaced apart intervals of increasing dosage amounts; and (2) monitoring the patient for adverse reactions.

At the end of RDD2 the patient will ingest said medical food product having a known concentration each day for a second time period, then continuing treatment of administering said medical food each day using a medical food of specified dosage, and increasing in dosage in the medical food ingested in regular time intervals; and continuing treatment by directly ingesting each day the allergy inducing food for the specific allergy in place of the medical food, and increasing the amounts of allergy inducing food ingested in regular time intervals. At the end of the treatment, the patient will maintain an ongoing treatment protocol through ingestion at specified intervals.

The step of preparing an allergy treatment powder further includes the step of creating multiple allergy treatment powders having different concentrations of said allergen materials using serial dilution with a base material that is non-reactive for the specific target food allergy.

A third rapids desensitization day (RDD3) may be added and wherein said different dosage amounts during said RDD1 and RDD2 are increasing dosage amounts and increasing dosages are also applied during RDD3.

With regards to RDD1, at least six doses are given in 15-60 minute intervals, preferably 15-30 minute intervals and more preferably 20 minute intervals wherein said second dose includes 3 times, said third dose includes 8 times, said fourth dose includes 20 times, said fifth dose includes 50 times and said sixth dose includes 100 times.

During RDD2 the dosing includes 3-6 times more of the specific allergen than said first dose on said RDD2, and said last dose on said RDD3 includes 3-6 times more of the specific allergen than said first dose on said RDD3. The method wherein the interval between said RDD1 and RDD2, and said RDD2 an RDD3 is a week, and wherein said step of continuing treatment of administering said medical food each day using a medical food of specified dosage lasts for at least eight weeks, and said step of continuing treatment by directly ingesting each day the allergy inducing food for the specific allergy in place of the medical food, lasts for at least ten weeks.

If the specific target food allergy is a nut allergy then for at least two weeks following the completion of treatment using a medical food the patient will daily ingest a flour made from the nut and for the remaining weekly period directly ingest at least one nut to which the patient is allergic, and then maintaining an ongoing treatment protocol includes daily ingesting of the specific allergy.

The present invention is directed to a method of desensitizing a patient to a specific target allergy using a medical food free of pharmaceutical agents, said method comprising: preparing at least six allergy treatment powders through serial dilution the following steps, (1) preparing a first allergy treatment powder, from a base material that in non-reactive for the specific target allergy and an allergen material, wherein the specific concentration of the allergen material in said allergy treatment is known; (2) preparing a second allergy treatment powder having a lesser concentration of the allergen material by diluting said first allergy treatment powder with said base material; (3) preparing a third allergy treatment powder having a lesser concentration of the allergen material than said second allergy treatment powder by diluting said second allergy treatment powder with said base material; (4) preparing a fourth allergy treatment powder having a lesser concentration of the allergen material than said third allergy treatment powder by diluting said third allergy treatment powder with said base material preparing a fifth allergy treatment powder having a lesser concentration of the allergen material than said fourth allergy treatment powder by diluting said fourth allergy treatment powder with said base material; and (5) preparing a sixth allergy treatment powder having a lesser concentration of the allergen material than said fifth allergy treatment powder by diluting said second allergy treatment powder with said base material. Then conducting a first rapid desensitization day (RDD1) through the following steps: (A) administering a first medical food product prepared by adding a first amount of said sixth allergy treatment powder to a non-reactive food product; (B) administering a second medical food product 15-60 minutes after said step of administering a first medical food product, and wherein said second medical food product is prepared by adding a second amount of said sixth allergy treatment powder to a non-reactive food product, and wherein said second amount of said sixth allergy treatment powder is greater than said first amount; (C) administering a third medical food product 15-60 minutes after said step of administering a second medical food product, and wherein said third medical food product is prepared by adding a third amount of said sixth allergy treatment powder to a non-reactive food product, and wherein said third amount of said sixth allergy treatment powder is greater than said first and second amount; (D) administering a fourth medical food product 15-60 minutes after said step of administering a third medical food product, and wherein said fourth medical food product is prepared by adding a first specified amount of said fifth allergy treatment powder to a non-reactive food product and wherein the total allergen weight in said fourth medical food product is greater than the amount in said first, second and third medical food products; (E) administering a fifth medical food product 15-60 minutes after said step of administering a fourth medical food product, and wherein said fifth medical food product is prepared by adding a second specified amount of said fifth allergy treatment powder to a non-reactive food product, and wherein said second specified amount of said fifth allergy treatment powder is greater than said first specified amount; and (F) administering a sixth medical food product 15-60 minutes after said step of administering a fifth medical food product, and wherein said sixth medical food product is prepared by adding a first set amount of said fourth allergy treatment powder to a non-reactive food product, and wherein the total allergen weight in said sixth medical food product is greater than the amount in said first, second, third, fourth, and fifth medical food products. During the treatment, monitoring during each step of administering for any reaction by the patient to the allergen and assessing the amount of reaction to determine if the next step of administering should be performed and only administering the next step when any reaction is within an acceptable reaction. Then providing the patient with individual daily doses of either said sixth medical food product or said fourth allergy treatment powder for said patient to add to a non-reactive food product to create said sixth medical food product with the proper daily dosage. Conducting a second rapid desensitization day (RDD2), after at least five days of ingesting individual doses using either said sixth medical food product or said fourth allergy treatment powder, with the following steps: (1) administering a seventh medical food product prepared by adding a first amount of said fourth allergy treatment powder to a non-reactive food product and wherein said seventh medical food product is prepared by adding a second set amount of said fourth allergy treatment powder to a non-reactive food product, and wherein the total allergen weight in said seventh medical food product is greater than the amount in said sixth medical food product, and more than the individual daily doses taken by the patient between said RDD1 and RDD2; (2) administering an eighth medical food product 15-60 minutes after said step of administering a seventh medical food product, and wherein said eighth medical food product is prepared by adding a third set amount of said fourth allergy treatment powder to a non-reactive food product, and wherein the total allergen weight in said eighth medical food product is greater than the amount in said seventh medical food product; and (3) administering a ninth medical food product 15-60 minutes after said step of administering an eighth medical food product, and wherein said ninth medical food product is prepared by adding a measured amount of said third allergy treatment powder to a non-reactive food product and wherein said ninth medical food product includes more allergen material than said first through eighth medical food products. Then providing the patient with individual daily doses of either said ninth medical food product or individual doses of said third allergy treatment powder used to create said ninth medical food product, for said patient to add to a non-reactive food product to create said ninth medical food product with the proper daily dosage. Next conducting a third rapid desensitization day (RDD3), after at least five days of ingesting individual doses using either said sixth medical food product or said fourth allergy treatment powder, with the following steps: (A) administering a tenth medical food product prepared by adding a second measured amount of said third allergy treatment powder to a non-reactive food product and wherein the total allergen weight in said tenth medical food product is greater than the amount in said first through ninth medical food product, and more than the individual daily doses taken by the patient between said RDD1 and RDD2, as well as between RDD2 and RDD3; (B) administering an eleventh medical food product 15-60 minutes after said step of administering a tenth medical food product, and wherein said eleventh medical food product is prepared by adding a third measured amount of said third allergy treatment powder to a non-reactive food product, and wherein the total allergen weight in said eleventh medical food product is greater than the amount in said tenth medical food product; and (C) administering a twelfth medical food product 15-60 minutes after said step of administering an eleventh medical food product, and wherein said twelfth medical food product is prepared by adding a measured amount of said second allergy treatment powder to a non-reactive food product and wherein said twelfth medical food product includes more allergen material than said first through eleventh medical food products.

During each rapid desensitization day, monitoring during each step of administering for any reaction by the patient to the allergen and assessing the amount of reaction to determine if the next step of administering should be performed and only administering the next step when any reaction is within an acceptable reaction.

Next providing the patient with individual daily doses which contain either said first and said second allergy treatment powder and wherein said daily doses increase every dosage period, which is five to twelve days, and wherein in each dosage period the amount of allergen included in the daily dosage increases as compared to the prior dosage period.

The remaining treatment protocol for additional dosage periods, with each dosage period including increasing amounts of allergen and wherein the patient during this remaining treatment protocol will directly intake the allergy material and not the allergy treatment powder. Then the patient will complete an oral challenge and upon successfully completing the oral challenge perform ongoing maintenance by daily ingesting the target food allergen. The method may include the step where the dry powder mixtures are made through serial dilution with each successive dilution including only 10% of the allergen in the prior material, and wherein the base material is isomalt. The allergen material includes a specific allergy protein wherein the specific allergy protein is provided in a known concentration, and the allergy treatment powder is divided into specific capsules.

### BRIEF DESCRIPTION OF DRAWINGS

FIG. 1 is a schematic diagram showing the treatment regime.

FIG. 2 is a schematic diagram showing the treatment regime with increasing dosages.

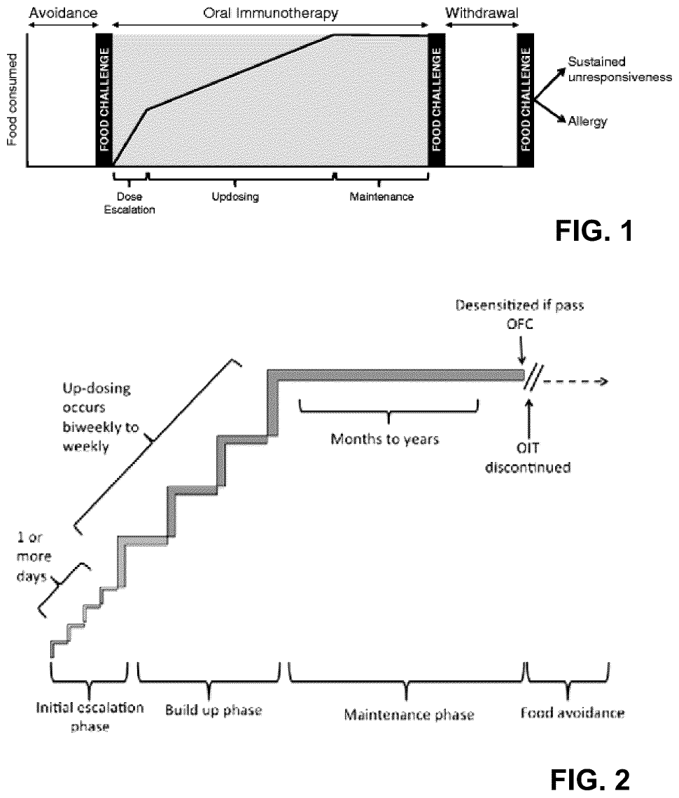

### DETAILED DESCRIPTION OF THE INVENTION

A “medical food”, as used herein is defined in section 5(b)(3) of the Orphan Drug Act (21 U.S.C. 360ee(b)(3)), is “a food which is formulated to be consumed or administered internally under the supervision of a physician and which is intended for the specific dietary management of a disease or condition for which distinctive nutritional requirements, based on recognized scientific principles, are established by medical evaluation.”

Oral immunotherapy can be considered as a form of dietary management of food allergies, as the distinctive nutritional requirement is traditionally for complete avoidance of the allergenic food. Because introduction of an allergen to a person with allergies may have medical complications, any oral immunotherapy needs to be done under medical supervision because of the potential for allergic reactions and treatment decisions required during the course of treatment. The medical food of the present invention is formulated very precisely and accurately before it is consumed to ensure benefit and minimize risk. As such, food oral immunotherapy, as long as the constituents are foods, would fit the definition of a medical food.

Though the FDA does not regulate medical foods as drugs, labeling requirements typically include a statement of identity, net quantity, name and place of the manufacturer, and a complete list of ingredients. In the example of peanut allergy management the ingredients would be peanuts and water or peanuts and isomalt.

A common food source for peanuts has been Byrdmill peanut flour 28% light roast with a serving size of ¼ cup (22 g), 120 total calories, 60 calories from fat, 6 g of total fat, 5 g total carbohydrates, 2 g of dietary fiber, and 9 g of protein. Another common food source could be PB2 Pure peanut powder, with a serving size of 2 Tbsp (13 g), 60 total calories, 1.5 g of total fat, 4 g of total carbohydrates, 1 g of dietary fiber, and 6 g of protein 6 g. Isomalt is a sugar alcohol used in the baking industry. More specifically, Isomalt is a sugar alcohol. It is made up of 2 disaccharide alcohols (gluco-mannital and gluco-sorbitol) and is a commercially available food.

It is a commercially available product used for making jewels for cakes and is available at baking supply stores. It is an equal part mixture of two disaccharides (gluco-mannitol and gluco-sorbitol). It is generally recognized as safe for consumption. The data reflecting the first 50 patients treated with the current method reflects the use of Byrdmill peanut flour mixed with isomalt, described in detail below. Current patients have been enrolled using PB2 pure and isomalt, described in detail below.

There is a distinction between a biologic pharmaceutical agent and a medical food as it applies to Palforzia and the current invention. Palforzia is an FDA-approved oral immunotherapy pharmaceutical agent. As described in the Palforzia patent U.S. Pat. No. 9,526,781 B2 the peanut flour is formulated into a pharmaceutical composition, therefore cannot be used as or in a medical food. This is in contrast to the current invention using commercially available peanut flour or peanut powder. The fact that the Palforzia patents were granted supports this distinction as commercially available peanut flour mixed with water had been used for oral immunotherapy treatment of peanut allergy, and this practice and method was well known, prior to the Palforzia patents being granted. The Palforzia patents also define their product as a formulation or pharmaceutical composition comprising peanut flour and optionally one or more glider, lubricant and diluent. In no part of the Palforzia patents do they claim that their product is a food diluted with a food. The Palforzia patents discuss possible diluents including sugars (including sucrose, mannitol, sorbitol etc.).

Thus using peanut flour or peanut powder diluted with isomalt (both foods), fits the definition of a medical food and is distinct from any product or treatment that includes a pharmaceutical agent, such as Palforzia. LoxOral, as mentioned above, which have been added or promoted as a diluent for peanut flour among oral immunotherapy practitioners. This practice of using LoxOral to dilute peanut flour for oral immunotherapy may also predate the Palforzia patents. The higher success rates (92%) of the current invention compared to the Wasserman and Palforzia data may be related to the formula (mixing peanut flour and isomalt) as well as the method (staring at a lower dose and escalating more slowly at first). The current invention, being a medical food that may have greater efficacy, is more readily available, at lower cost could result in more individuals receiving life-saving treatments.

It should be noted that the present invention starts with a dose that is about 10% as compared to the prior art, and has been found that by starting lower, the chances of reacting early in the process are decreased. In addition, the present invention uses three rapid desensitization days (RDD1, RDD2, and RDD3) which are lacking in any of the prior art. Furthermore, the present invention also uses a slower ramp up on the first rapid desensitization day (RDD1) as compared the initial multi-dose taught by Waserman, and the present invention does not even reach the same dosage of Wasserman until the process reaches the third rapid desensitization day (RDD3).

The individual doses listed in my RDD1, RDD2 or RDD3 days (ex. 3 capsules of 1:1,000,000) refer to the number and concentration of capsules emptied into apple sauce or similar and taken (eaten) at once. The next doses are given at approximately 20 minute intervals, again with reference to the number of capsules added into the food. For example, as seen below RDD1 is typically 6 doses each about 20 minutes apart or occurring over at least a two hour period, with RDD2 and RDD3 typically 3 doses also approximately 20 minutes apart.

Keeping the dry powders (e.g. nut flours, wheat flour and sesame seed four) in powder form and not mixing with water, we have found to increase shelf life and minimize dose to dose variation. In comparison, in the prior art method of Wasserman, the dry flours are mixed into water, and as they do not dissolve in water, they thus they become a suspension. When the flour concentration increases there is an increased risk for clumping to occur in the solutions since the flours did not actually dissolve. If clumping occurs and a dose is given out of that solution a lower than expected dose will be delivered. If a patient gets a dose that has a clump in it, then a higher than expected dose will be delivered thus increasing the chance of a reaction. It has been found that keeping the flours in dry powder form decreases the dose to dose variation and decreases the risk of reactions during the process of desensitization.

All maintenance doses are given daily (the only exception is cashew alternating with pistachio as these can be substituted as they are cross reactive as described below). Maintenance doses are started after the patients have passed the oral challenge for that particular food. In an oral challenge (“OC”) they attempt to eat the specified food and are monitored for reaction. When the protocols and examples below list a dose for a given week (ex. Week 3—1 capsule of 1:100), that represents the dose given in the office during an up-dose visit. Assuming that the patient tolerates that dose they will then be consuming that dose daily during that week until their next up-dose visit (typically a 1 week interval, unless there are scheduling difficulties or they have had reactions) at which time they would get the next dose (ex. 2 capsules of 1:100). As such, each increase has a first dose applied and monitored for a reaction.

More specifically, instructions for mixing the medical foods used for oral immunotherapy are as follows. The first step is to calculate the protein content of the food powder per unit volume. These values are at times listed on the package in the nutritional content and other times they will be from other sources. Once the protein content per unit volume is known it is an easy calculation for the content per 0.9 cc which is the volume of the 00 capsules. Isomalt is ground to a similar consistency as the flours and is used as a dry diluent (ex. to make the 1:10 peanut dilution, 6 tablespoons (T) of PB2 peanut powder are mixed into 54 T of isomalt). Tenfold dilutions are done in a serial fashion resulting in 1:10, 1:100, 1:1,000, 1:10,000, 1:100,000 and 1:1,000,000 concentrations. These concentrations are placed into 00 capsules. The appropriate number and concentration of capsules (ex. 2 capsules of 1:100,000 peanut) are opened and mixed into a small volume of apple sauce or other food for eating by the patient as their specific dose. The volume of apple sauce or similar food could be approximately 3-10 times the volume of the allergen dose, such as a peanut (or other food) dose itself (ex. the contents of 2 capsules could be mixed with a tablespoon of apple sauce and eaten). The specific volume of the food that the contents of the capsules are mixed with is not crucial but should not be excessive. The schematic above is a generic summary of an oral immunotherapy program. In our method the three rapid desensitization days (RDD1, RDD2, and RDD3) would be part of the initial dose escalation phase. Single up dosing visits would include visits 4 through 20 assuming no reactions. Visit 20 would consist of a 6 gram peanut challenge (OC) and assuming the patient passed they would then start 3 years of daily maintenance. The 3 years of daily maintenance would consist of 2 grams of peanut in this example. This could be 8 peanuts or an equivalent amount of peanut protein from another food source such as peanut butter or peanut powder. During maintenance the patient is considered fully desensitized and does not need to avoid other peanut products and does not need to read labels anymore.

In the following examples, during the rapid desensitization days, 20 minute intervals are used to space apart the dosages; however, intervals between 15-60 minutes may be acceptable, and are set based on the clinical comfort of the individuals and providers. Most common intervals would be 20-30 minutes, which allows enough time for a reaction, if any, yet minimizes the time the provider has to spend with any individual patient, allowing treatment of more individuals in a given day. In addition, references to no reaction, means no reaction of medical concern, a minor reaction not of medical concern to the allergen for purposes of the examples is considered “no reaction”. However, it is expected that even minor reactions will be taken into consideration before proceeding to the next step or next level of dosage, particularly for self-administered doses at the home of the patient, which are not done in a clinical setting.

### EXAMPLES

The following description is of a product and method for the treatment of severe food allergy utilizing a medical food incorporating the standard of care, peer-reviewed literature, and extensive clinical experience which may result in therapeutic and economic advantages.

The following are embodiments of the preparation, manufacture and treatment protocols for the management of various food allergies using commercially available food products which constitute a medical food approach for these treatments. The food mixtures (frequently nut flour, powder or meal and isomalt) are in dry form and are placed into 00 capsules (0.9 cc volume). The capsules are not swallowed but opened and the contents mixed with an additional food such as apple sauce or pudding and eaten as directed.

Instructions for a medical food oral immunotherapy method for peanut allergy: In this example, peanut flour from byrdmill.com was used having 9 gm peanut protein per 22 gm flour, which is about a quarter (¼) cup or 59.15 ml. As used herein gm is short for grams, and T is tablespoon, which is about 15 ml. The capsules used were 00 capsules, which hold about 0.9 ml or about 137 mg peanut protein. For the treatment protocol, the above was prepared and divided into capsules as follows:
1:10—6 T flour into 54 T isomalt into capsules (800)=13.7 mg/capsule
1:100—6 T 1:10 into 54 T isomalt into capsules (800)=1.37 mg/capsule
1:1,000—3 T 1:100 into 27 T isomalt into capsules (400)=0.137 mg/capsule
1:10,000—3 T 1:1,000 into 27 T isomalt into capsules (400)=0.0137 mg/capsule
1:100,000—2 tsp. 1:10,000 into 6 T isomalt into capsules (100)=0.00137 mg/capsule
1:1,000,000—2 tsp. 1:100,000 into 6 T isomalt into capsules (100)=0.000137 mg/capsule

### Rapid Desensitization—Day 1—(“RDD1”)

The protocol includes dosing in non-reactive beverage of choice, applesauce or pudding, as each capsule mentioned below is taken as part of a non-reactive food. On RDD1 this dosing occurs at 20 minute intervals the following in order:
1 capsule of 1:1,000,000 (0.000137 mg)
3 capsules of 1:1,000,000 (0.000411 mg)
8 capsules of 1:1,000,000 (0.0011 mg)
2 capsule of 1:100,000 (0.00274 mg)
5 capsule of 1:100,000 (0.00685 mg)
1 capsule of 1:10,000 (0.0137 mg)
   Week 1—1 Capsule of 1:10,000 (0.0137 mg) Each Day, which Starts on Day 2

Rapid desensitization day 2 (“RDD2”)—each of the following is given in approximately 20 minute intervals, and in this example, if RDD1 is on Monday, they would do RDD2 on Monday or after. Preferably the patient will maintain a stable dose for at least a week, and RDD2 could after the week period and for example occur even at week 2 or about 14 days after RDD1.
2 capsule of 1:10,000 (0.0274 mg)
5 capsule of 1:10,000 (0.0685 mg)
1 capsule of 1:1,000 (0.137 mg)

### Week 2—1 Capsule of 1:1,000 (0.137 mg) Each Day

Rapid desensitization day 3 (RDD3) and in this example, if RDD2 is on Monday, they would do RDD3 on Monday or after. Preferably the patient will maintain a stable dose for at least a week, and RDD3 could after the week period and for example occur even at week 2 or about 14 days after RDD2. It has been found preferable that updosing at RDD2 and RDD3 only occurs after at least a week has passed since the prior rapid desensitization day.
2 capsule of 1:1,000 (0.274 mg)
5 capsule of 1:1,000 (0.685 mg)
1 capsule of 1:100 (1.37 mg)

The protocol then follows the following dosages each day of the specified week.
Week 3—1 capsule of 1:100 (1.37 mg)
Week 4—2 capsules of 1:100 (2.74 mg)
Week 5—4 capsules of 1:100 (5.48 mg)
Week 6—7 capsule of 1:100 (9.6 mg)
Week 7—1 capsule of 1:10 (13.7 mg)
Week 8—2 capsules of 1:10 (27.4 mg)
Week 9—4 capsules of 1:10 (54.8 mg)
Week 10—7 capsules of 1:10 (96.0 mg)
Week 11—1 capsule of peanut flour (137 mg)
Week 12—2 capsule of peanut flour (274 mg)
Week 13—1 peanut
Week 14—2 peanuts
Week 15—3 peanuts
Week 16—4 peanuts
Week 17—6 peanuts
Week 18—9 peanuts
Week 19—12 peanuts
Week 20—24 peanuts—oral challenge

After completion of the treatment protocol, the patient of person being treated should continue ongoing maintenance of 8 peanuts or equivalent each day, which may vary due to the size, age and other factors.

The following is directions for using a different medical food to treat a peanut allergen, specifically instructions for oral immunotherapy for peanut. In this example, PB2 Pure Peanut powder from PB2 was used, which is peanut flour 6 gm peanut protein per 30 ml peanut powder. As such the 00 capsules which are about 0.9 ml each and include a total of 180 mg of peanut protein. For the treatment protocol, the above was prepared and divided into capsules as follows:
1:10—6 T flour into 54 T isomalt into capsules (800)=18 mg/capsule
1:100—6 T 1:10 into 54 T isomalt into capsules (800)=1.8 mg/capsule
1:1,000—3 T 1:100 into 27 T isomalt into capsules (400)=0.18 mg/capsule
1:10,000—3 T 1:1,000 into 27 T isomalt into capsules (400)=0.018 mg/capsule
1:100,000—2 tsp 1:10,000 into 6 T isomalt into capsules (100)=0.0018 mg/capsule
1:1,000,000—2 tsp 1:100,000 into 6 T isomalt into capsules (100)=0.00018 mg/capsule

### Rapid Desensitization—Day 1—RDD1

The protocol includes dosing in non-reactive beverage of choice, applesauce or pudding, as each capsule mentioned below is taken as part of a non-reactive food. On RDD1 this dosing occurs at 20 minute intervals the following in order:

RDD1—dosing (in non-reactive beverage of choice or applesauce or pudding at 20 minute intervals):
1 capsule of 1:1,000,000 (0.00018 mg)
3 capsules of 1:1,000,000 (0.00054 mg)
8 capsules of 1:1,000,000 (0.00144 mg)
2 capsule of 1:100,000 (0.0036 mg)
5 capsule of 1:100,000 (0.009 mg)
1 capsule of 1:10,000 (0.018 mg)

### Week 1—1 Capsule of 1:10,000 (0.018 mg) Each Day

### Rapid Desensitization Day 2

2 capsule of 1:10,000 (0.036 mg)
5 capsule of 1:10,000 (0.09 mg)
1 capsule of 1:1,000 (0.18 mg)

### Week 2—1 Capsule of 1:1,000 (0.18 mg) Each Day

### Rapid Desensitization Day 3

2 capsule of 1:1,000 (0.36 mg)
5 capsule of 1:1,000 (0.9 mg)
1 capsule of 1:100 (1.8 mg)

The protocol then follows the following dosages each day of the specified week.
Week 3—1 capsule of 1:100 (1.8 mg)
Week 4—2 capsules of 1:100 (3.6 mg)
Week 5—4 capsules of 1:100 (7.2 mg)
Week 6—7 capsules of 1:100 (12.6 mg)
Week 7—1 capsule of 1:10 (18 mg)
Week 8—2 capsules of 1:10 (36 mg)
Week 9—4 capsules of 1:10 (72 mg)
Week 10—7 capsules of 1:10 (126 mg)
Week 11—1 capsule of peanut flour (180 mg)
Week 12—2 capsule of peanut flour (360 mg)
Week 13—1 peanut
Week 14—2 peanuts
Week 15—3 peanuts
Week 16—4 peanuts
Week 17—6 peanuts
Week 18—9 peanuts
Week 19—12 peanuts
Week 20—24 peanuts—oral challenge
Maintenance—8 peanuts

After completion of the treatment protocol, the patient of person being treated should continue ongoing maintenance of 8 peanuts or equivalent each day, which may vary due to the size, age and other factors.

Even though the above examples were both directed to peanut allergies, the protocol may be extended to other allergies, particularly other nut allergies.

For example, a protocol for treating with a medical food oral immunotherapy method for hazelnut allergy would include:
Obtaining a hazelnut flour having about 6 gm hazelnut protein/28 gm flour or about 1 oz. The specific hazelnut powder on the label had 6 gm/oz.=28 gm (label), T has an average weight of 4.6488 gm

The calculation of protein content per capsule protein per tablespoon is calculated as follows:

Protein/T=(6/28)4.6488=0.996 gm/T a.

0.996 gm/15cc, OO cap=0.9cc, 0.996/(15/0.9)=59.76 mg/cap b.

The following is directions for using a different medical food to treat a hazelnut allergen, specifically instructions for oral immunotherapy for Hazelnut. As such the 00 capsules which are 0.9 ml each and include a total of 59.76 mg of hazel nut protein. For the treatment protocol, the above was prepared and divided into capsules as follows:
1:10—6 T flour added into 54 T isomalt into capsules (800)=5.98 mg/capsule
1:100—6 T 1:10 into 54 T isomalt into capsules (800)=0.598 mg/capsule
1:1,000—3 T 1:100 into 27 T isomalt into capsules (400)=0.0598 mg/capsule
1:10,000—3 T 1:1,000 into 27 T isomalt into capsules (400)=0.00598 mg/capsule
1:100,000—2 tsp. 1:10,000 into 6 T isomalt into capsules (100)=0.000598 mg/capsule

### Rapid Desensitization Day 1—RDD1 (Supervised Visit #1)

RDD1—dosing (in non-reactive beverage of choice or applesauce or pudding at 20 minute intervals):
1 capsule of 1:100,000 (0.0006 mg)
3 capsules of 1:100,000 (0.0018 mg)
8 capsules of 1:100,000 (0.0048 mg)
2 capsule of 1:10,000 (0.012 mg)
5 capsule of 1:10,000 (0.03 mg)
1 capsule of 1:1,000 (0.06 mg)

Week 1—1 capsule of 1:1,000 (0.0598 mg) each day. For all examples, week 1 (and all subsequent weeks) occurs if no reaction, or only minimal non-life-threatening reaction during the RDD1, then treat with capsule for each day of the week, followed by Supervised Visit #2, to discuss if there was any reaction.

### Rapid Desensitization Day 2—RDD2 (Supervised Visit #2)

2 capsule of 1:1,000 (0.12 mg)
5 capsule of 1:1,000 (0.3 mg)
1 capsule of 1:100 (0.6 mg)

Week 2—1 capsule of 1:100 (0.6 mg) each day. If no reaction on RDD2, then treat at week 2 with the recommended amount.

### Rapid Desensitization Day 3—RDD3 (Supervised Visit #3)

2 capsule of 1:100 (1.2 mg)
4 capsule of 1:100 (2.4 mg)

The protocol then follows the following dosages each day of the specified week, assuming no reaction of
Week 3—4 capsule of 1:100 (2.4 mg) each day
Week 4—7 capsule of 1:100 (4.2 mg)
Week 5—1 capsule of 1:10 (5.98 mg)
Week 6—2 capsules of 1:10 (12 mg)
Week 7—4 capsules of 1:10 (24 mg)
Week 8—7 capsules of 1:10 (42 mg)
Week 9—1 capsule of hazelnut flour (60 mg)
Week 10—2 capsule of hazelnut flour (120 mg)
Week 11—1 hazelnut
Week 12—2 hazelnuts
Week 13—3 hazelnuts
Week 14—4 hazelnuts
Week 15—6 hazelnuts
Week 16—9 hazelnuts
Week 17—12 hazelnuts
Week 18—24 hazelnuts—oral challenge
Maintenance—8 hazelnuts per day.

As previously stated, the treatment protocol may be used for a variety of allergens, including as described below in this example for a pecan allergy. Instructions for oral immunotherapy for pecan: In this example, pecan meal was obtained having 3 gm pecan protein/30 gm meal material.=1.1 oz.=32.53 ml. The 00 capsules are filled with 9 ml of or 83 mg pecan protein as follows.
1:10—6 T flour into 54 T isomalt into capsules (800)=8.3 mg/capsule
1:100—6 T 1:10 into 54 T isomalt into capsules (800)=0.83 mg/capsule
1:1,000—3 T 1:100 into 27 T isomalt into capsules (400)=0.083 mg/capsule
1:10,000—3 T 1:1,000 into 27 T isomalt into capsules (400)=0.0083 mg/capsule
1:100,000—2 tsp 1:10,000 into 6 T isomalt into capsules (100)=0.00083 mg/capsule

### Rapid Desensitization Day 1—RDD1

### RDD1—Dosing (in Non-Reactive Beverage of Choice or Applesauce or Pudding or Similar Food at 20 Minute Intervals):

1 capsule of 1:100,000 (0.00083 mg)
3 capsules of 1:100,000 (0.00249 mg)
8 capsules of 1:100,000 (0.00664 mg)
2 capsule of 1:10,000 (0.0166 mg)

### Week 1—2 Capsule of 1:10,000 (0.0166 mg) Each Day

### Rapid Desensitization Day 2—RDD2

5 capsule of 1:10,000 (0.0415 mg)
1 capsule of 1:1,000 (0.083 mg)
2 capsule of 1:1,000 (0.166 mg)

### Week 2—2 Capsules of 1:1,000 (0.138 mg) Each Day

### Rapid Desensitization Day 3

5 capsule of 1:1,000 (0.415 mg)
1 capsule of 1:100 (0.83 mg)
2 capsule of 1:100 (1.66 mg)
Week 3—2 capsule of 1:100 (1.66 mg)
Week 4—4 capsule of 1:100 (3.32 mg)
Week 5—7 capsules of 1:100 (5.81 mg)
Week 6—1 capsule of 1:10 (8.3 mg)
Week 7—2 capsules of 1:10 (16.6 mg)
Week 8—4 capsules of 1:10 (33.2 mg)
Week 9—7 capsules of 1:10 (58.1 mg)
Week 10—1 capsule of pecan meal (83 mg)
Week 11—2 capsules of pecan meal (166 mg)
Week 12—1 pecan (276 mg)
Week 13—2 pecans
Week 14—3 pecans
Week 15—4 pecans
Week 16—6 pecans
Week 17—8 pecans
Week 18—10 pecans
Week 19—15 pecans (oral challenge)
Week 20—7 pecans per day maintenance (2 gm maintenance)

Example instructions for a medical food oral immunotherapy method for walnut allergy, using walnut meal having 5 gm walnut protein in each 30 gm of meal, or about 1.1 oz of meal. 30 grams of meal is about 32.53 ml of material.

For the treatment of walnut allergy, 00 capsules, which contain 0.9 ml of material using 138 g walnut protein. The capsules are prepare as follows:
1:10—6 T flour into 54 T isomalt into capsules (800)=13.8 mg/capsule
1:100—6 T 1:10 into 54 T isomalt into capsules (800)=1.38 mg/capsule
1:1,000—3 T 1:100 into 27 T isomalt into capsules (400)=0.138 mg/capsule
1:10,000—3 T 1:1,000 into 27 T isomalt into capsules (400)=0.0138 mg/capsule
1:100,000—2 tsp. 1:10,000 into 6 T isomalt into capsules (100)=0.00138 mg/capsule
1:1,000,000—2 tsp. 1:100,000 into 6 T isomalt into capsules (100)=0.000138 mg/capsule

The treatment protocol because with first the Rapid desensitization day 1—RDD1

### RDD1—Dosing (in Non-Reactive Beverage of Choice or Applesauce or Pudding) at 20 Minute Intervals to Following in Order:

1 capsule of 1:1,000,000 (0.000138 mg)
3 capsules of 1:1,000,000 (0.000414 mg)
8 capsules of 1:1,000,000 (0.0011 mg)
2 capsule of 1:100,000 (0.00276 mg)
5 capsule of 1:100,000 (0.0069 mg)
1 capsule of 1:10,000 (0.0138 mg)

### Week 1—1 Capsule of 1:10,000 (0.0138 mg) Each Day

Rapid desensitization day 2 includes dosing similar to RDD1 in intervals in the following order, approximately 20 minutes apart.
2 capsule of 1:10,000 (0.0276 mg)
5 capsule of 1:10,000 (0.069 mg)
1 capsule of 1:1,000 (0.138 mg)
   Week 2—1 capsule of 1:1,000 (0.138 mg) each day

Rapid desensitization day 3—RDD2 includes dosing similar to RDD1 and RDD2 in the following twenty minute intervals and amounts:
2 capsule of 1:1,000 (0.276 mg)
5 capsule of 1:1,000 (0.69 mg)
1 capsule of 1:100 (1.38 mg)

The protocol then follows the following dosages each day of the specified week.
Week 3—1 capsule of 1:100 (1.38 mg)
Week 4—2 capsules of 1:100 (2.76 mg)
Week 5—4 capsules of 1:100 (5.52 mg)
Week 6—7 capsule of 1:100 (9.66 mg)
Week 7—1 capsule of 1:10 (13.8 mg)
Week 8—2 capsules of 1:10 (27.6 mg)
Week 9—4 capsules of 1:10 (55.2 mg)
Week 10—7 capsules of 1:10 (96.6 mg)
Week 11—1 capsule of walnut meal (138 mg)
Week 12—2 capsules of walnut meal (276 mg)
Week 13—½ walnut (308 mg)
Week 14—1 walnut
Week 15—2 walnuts
Week 16—3 walnuts
Week 17—4 walnuts
Week 18—6 walnuts
Week 19—10 walnuts—oral challenge
Maintenance—3.5 walnuts by the patient each day.

The present invention may also be used for treating cashew and pistachio allergies as follows with a medical food oral immunotherapy method for cashew and pistachio allergy:

First cashew and pistachio flour need to be obtained. Treatment can be for just cashews or pistachios, or for both. In regards to cashews, the cashew flour in the following example had 5 gm cashew protein in 28 gm flour. As such a ¼ cup or about 59.15 ml was about 22 gm flour and about 4 gm cashew protein. As with before, the allergen was placed in 00 capsules, which contain about 0.9 ml, which would allow 61 mg of cashew protein. In regards to pistachios, pistachio flour was obtained, containing 6 gm of pistachio protein for each 28 grm of pistachio flour. It should be noted for all examples, that the about of allergen introduced is the important number and the amount of flour of other material containing the flour may vary depending on how much allergen is in each sample, so for example, if a pistachio flour that had substantially higher amounts of pistachio protein per a specified weight of the flour, the weight of the flour used would be adjusted downward. In the present example, a ¼ cup of cashew flour or about 59.15 ml was prepared which had 22 grams of cashew flour and 4.7 grams of cashew protein, and for pistachios. As such, Pistachio flour having 6 gm pistachio protein/28 gm flour was prepared with ¼ cup=59.15 ml=22 gm flour=4.7 gm cashew protein, and 00 capsules=0.9 cc=or about 71.5 mg pistachio protein per capsule.

The capsules are prepared as follows:
1:10—3 T each flour into 54 T isomalt into capsules (800)=13.25 mg/capsule
(13.25 total mg, 6.1 mg cashew+7.15 mg pistachio protein)
1:100—6 T 1:10 into 54 T isomalt into capsules (800)=1.325 mg/capsule
1:1,000—3 T 1:100 into 27 T isomalt into capsules (400)=0.1325 mg/capsule
1:10,000—3 T 1:1,000 into 27 T isomalt into capsules (400)=0.01325 mg/capsule
1:100,000—2 tsp. 1:10,000 into 6 T isomalt into capsules (100)=0.001325 mg/capsule
1:1,000,000—2 tsp. 1:100,000 into 6 T isomalt into capsules (100)=0.0001325 mg/capsule

The treatment is started with a Rapid desensitization day 1—RDD1, where dosing using medical food including the allergen in a non-reactive beverage of choice or applesauce or pudding at 20 minute intervals occurs. The protocol includes the following dosing at 20 minute intervals:
1 capsule of 1:1,000,000 (0.0001325 mg)
3 capsules of 1:1,000,000 (0.0003975 mg)
8 capsules of 1:1,000,000 (0.00106 mg)
2 capsule of 1:100,000 (0.00265 mg)
5 capsule of 1:100,000 (0.006625 mg)
1 capsule of 1:10,000 (0.01325 mg)

### Week 1—1 Capsule of 1:10,000 (0.01325 mg) Each Day

During the Rapid desensitization day 2 or RDD2, the following is introduced at intervals:
2 capsule of 1:10,000 (0.0265 mg)
5 capsule of 1:10,000 (0.06625 mg)
1 capsule of 1:1,000 (0.1325 mg)

### Week 2—1 Capsule of 1:1,000 (0.1325 mg) Each Day

Rapid desensitization day 3 the following is introduced:
2 capsule of 1:1,000 (0.265 mg)
5 capsule of 1:1,000 (0.6625 mg)
1 capsule of 1:100 (1.325 mg)

Following RDD3, increasing amounts of allergen are introduced as follows.
Week 3—1 capsule of 1:100 (1.325 mg)
Week 4—2 capsules of 1:100 (2.65 mg)
Week 5—4 capsules of 1:100 (5.3 mg)
Week 6—7 capsule of 1:100 (9.28 mg)
Week 7—1 capsule of 1:10 (13.25 mg)
Week 8—2 capsules of 1:10 (26.5 mg)
Week 9—4 capsules of 1:10 (53 mg)
Week 10—7 capsules of 1:10 (92.8 mg)
Week 11—1 capsule of cashew and 1 capsule of pistachio flour (132.5 mg total)
Week 12—2 capsule of each flour (265 mg)
Week 13—½ cashew (125 mg) and 1 pistachio (140 mg)
Week 14—1 cashews (250) and 2 pistachios (240 mg)
Week 15—2 cashews and 3 pistachios
Week 16—3 cashews and 4 pistachios
Week 17—4 cashews and 6 pistachios
Week 18—6 cashews and 9 pistachios
Week 19—9 cashews and 12 pistachios
Week 20—12 cashews and pistachios
Week 21—24 cashews and pistachios—oral challenge
Maintenance each day of 8 cashews alternating some days with 8 pistachios 2-3 times a week

As stated above, multiple allergies may be treated through a single treatment protocol. The following example provides the protocol and instructions for a medical food oral immunotherapy method for tree nut allergy (including almond, Brazil nut, cashew, hazelnut, macadamia, pistachio, pecan, walnut). Other nuts could be substituted and multiple versions of nuts could be substituted. In this example, one would obtain nut flours for each of them and mixed evenly with one part of each nut flour, except that macadamia and pecans would receive two parts of nut flours. This is because the available macadamia and pecan nut flours that were used had less mg of protein of each nut in the flour, and as seen below, the amount in mg in each prepared capsule had similar numbers of protein by weight. More specifically each capsule contained the following mg/capsule for each nut: (a) almond 7.92, (b) brazil 7.69, (c) cashew 6.26, (d) hazelnut 6, (e) macadamia 7.2, (f) pecan 6.9, (g) pistachio 7.72 and (h) walnut 5.56, and when blended are hereinafter referred to as “tree nut mixture” or “tree nut mix”, with the understanding that the individual components could be substituted, added to or subtracted, depending on what allergies need to be treated in an individual. The individual treatment capsules for inclusion in the medical food were prepared as follows:
1:10—6 T tree nut mixture into 54 T isomalt into capsules (800)=0.1×each mg/capsule
1:100—6 T 1:10 into 54 T isomalt into capsules (800)=0.01×each mg/capsule
1:1,000—3 T 1:100 into 27 T isomalt into capsules (400)=0.001×each mg/capsule
1:10,000—3 T 1:1,000 into 27 T isomalt into capsules (400)=0.0001×each mg/capsule
1:100,000—2 tsp. 1:10,000 into 6 T isomalt into capsules (100)=0.00001×each mg/capsule

After preparation of the capsules, the patient is subjected to a rapid desensitization day 1—RDD1 wherein the prepared food is a non-reactive beverage or easy to swallow food, such as applesauce, pudding, jello, or even juice, with the treatment being administered at 20 minute intervals. The intervals may vary some, such as 15-60 minutes, typically 20-30 minutes, but 20 minutes has been found to work well for an interval doses. On RDD1, the dosing occurs as follows in 20 minute intervals.
1 capsule of 1:100,000
3 capsules of 1:100,000
8 capsules of 1:100,000
2 capsule of 1:10,000
5 capsule of 1:10,000
1 capsule of 1:1,000

### Week 1—1 Capsule of 1:1,000 Each Day

Rapid desensitization day 2—RDD2. The following treatment protocol in twenty minute intervals:
2 capsule of 1:1,000
5 capsule of 1:1,000
1 capsule of 1:100

### Week 2—1 Capsule of 1:100 Each Day.

Rapid Desensitization day 3 treatment as follows:
2 capsule of 1:100
5 capsule of 1:100
1 capsule of 1:10

After RDD3, weekly treatments occur as follows:
Week 3—1 capsule of 1:10
Week 4—2 capsules of 1:10
Week 5—4 capsules of 1:10
Week 6—7 capsule of 1:10
Week 7—1 capsule of tree nut mix
Week 8—2 capsules of tree nut mix
Week 9—4 capsules of tree nut mix
Week 10—1 tsp of tree nut mix
Week 11—1.5 tsp of tree nut mix
Week 12—2.5 tsp of tree nut mix
Week 13—4 tsp of tree nut mix
Week 14—1 almond, ¼ Brazil, ½ cashew, 1 hazelnut, ½ macadamia, ¼ pecan, 1 pistachio, ¼ walnut 2 week intervals (last 9 office visits)
Week 15—2 almond, ⅓ Brazil, 1 cashew, 2 hazelnut, 1 macadamia, ½ pecan, 2 pistachio, ⅓ walnut
Week 16—3 almond, ½ Brazil, 2 cashew, 3 hazelnut, 2 macadamia, 1 pecan, 3 pistachio, ½ walnut
Week 17—4 almond, ¾ Brazil, 3 cashew, 4 hazelnut, 3 macadamia, 2 pecan, 4 pistachio, ¾ walnut
Week 18—6 almonds, 1 Brazil, 4 cashews, 6 hazelnuts, 4 macadamia, 3 pecans, 6 pistachio, 1 walnut
Week 19—8 almond, 2 Brazil, 6 cashew, 9 hazelnut, 6 macadamia, 4 pecan, 9 pistachio, 1½ walnut
Week 20—10 almond, 3 Brazil, 9 cashew, 12 hazelnut, 9 macadamia, 6 pecan, 12 pistachio, 2 walnut
Week 21—12 almond, 5 Brazil (OC), 12 cashew, 24 hazelnut (OC), 12 macadamia, 8 pecan, 24 pistachio (OC), 3 walnut (as used herein OC means “oral challenge” and M means maintenance, wo that the oral challenge amounts are identified with OC, and the maintenance amounts are identified below with M).
Week 22—24 almond (OC), 1 Brazil (M), 24 cashew (OC), 8 hazelnut (M), 24 macadamia (OC), 10 pecan, 10 pistachio (M), 5 walnut
Week 23—8 almond (M), 1 Brazil (M), 8 cashew (M), 8 hazelnut (M), 8 macadamia (M), 15 pecan (OC), 10 pistachio (M), 10 walnut (OC)
Maintenance: 8 almond, 1 Brazil, 8 cashew, 8 hazelnut, 8 macadamia, 7 pecan, 10 pistachio, 3.5 walnut (cashews and pistachios do not need to both be dosed every day, recommendation: cashews most days alternating with pistachios 2-3 days a week, as cashew and pistachios are cross reactive nuts and help protect for the allergy to the other nut)

The treatment protocol may also be used to create a medical food oral immunotherapy method for treating a sesame seed allergy. First a sesame flour needs to be obtained, have sesame protein. In this example, the sesame flour has sesame flour 12 gm sesame protein in 30 gm flour which is about 30 cc. Again 00 capsules are used having about 0.9 ml of volume and enough flour is prepared to obtain about 360 mg sesame protein. The mixtures for the capsules are then prepared as follows:
1:10—6 T flour into 54 T isomalt into capsules (800)=36.0 mg/capsule
1:100—6 T 1:10 into 54 T isomalt into capsules (800)=3.60 mg/capsule
1:1,000—3 T 1:100 into 27 T isomalt into capsules (400)=0.360 mg/capsule
1:10,000—3 T 1:1,000 into 27 T isomalt into capsules (400)=0.036 mg/capsule
1:100,000—2 tsp. 1:10,000 into 6 T isomalt into capsules (100)=0.0036 mg/capsule

### Rapid Desensitization Day 1—RDD1

RDD1—dosing (in non-reactive beverage of choice or applesauce or pudding at 20 minute intervals):
1 capsule of 1:100,000 (0.0036 mg)
2 capsule of 1:100,000 (0.0072 mg)
5 capsule of 1:100,000 (0.018 mg)
1 capsule of 1:10,000 (0.036 mg)
2 capsule of 1:10,000 (0.072 mg)

### Week 1—2 Capsule of 1:10,000 (0.072 mg) Each Day

Rapid desensitization day 2 as follows:
5 capsule of 1:10,000 (0.18 mg)
1 capsule of 1:1,000 (0.36 mg)
2 capsule of 1:1,000 (0.72 mg)

### Week 2—2 Capsule of 1:1,000 (0.72 mg) Each Day

Rapid desensitization day 3—RDD3 includes treatment with the following in twenty minute intervals.
5 capsule of 1:1,000 (1.8 mg)
1 capsule of 1:100 (3.6 mg)

The protocol then includes treatment as follows:
Week 3—1 capsule of 1:100 (3.6 mg)
Week 4—2 capsules of 1:100 (7.2 mg)
Week 5—4 capsules of 1:100 (14.4 mg)
Week 6—7 capsule of 1:100 (25.2 mg)
Week 7—1 capsule of 1:10 (36 mg)
Week 8—2 capsules of 1:10 (72 mg)
Week 9—4 capsules of 1:10 (144 mg)
Week 10—7 capsules of 1:10 (252 mg)
Week 11—1 capsule of sesame flour (360 mg)
Week 12—2 capsule of sesame flour (720 mg)
Week 13—3 capsule of sesame flour (1080 mg)
Week 14—4 capsule of sesame flour (1440 mg)
Week 15—1 tsp. of sesame flour (2000 mg)
Week 16—1½ tsp. of sesame flour (3000 mg)—oral challenge
Ongoing daily maintenance includes—½ tsp. of sesame flour (1000 mg)

It should be noted that the treatment protocol is not limited to just nut allergies but may also be used for wheat allergies as well. The following is an example of treatment using the present invention to treat a wheat allergy using a medical food oral immunotherapy method for wheat allergy. First wheat flour having wheat gluten is obtained, such as Wheat flour from Druids Grove® Vital Wheat Gluten, which includes wheat flour having 70 gm wheat protein for each 100 gm flour, which means 1 tsp. flour has about 2.431 mg flour and 1.7017 mg wheat. Enough is prepared to fill 00 capsules, having about 0.9 ml of volume with 300 mg wheat protein. The following mixtures of food are prepared for placement into the capsules.
1:10—6 T flour into 54 T isomalt into capsules (800)=30.0 mg/capsule
1:100—6 T 1:10 into 54 T isomalt into capsules (800)=3.00 mg/capsule
1:1,000—3 T 1:100 into 27 T isomalt into capsules (400)=0.300 mg/capsule
1:10,000—3 T 1:1,000 into 27 T isomalt into capsules (400)=0.030 mg/capsule
1:100,000—2 tsp. 1:10,000 into 6 T isomalt into capsules (100)=0.003 mg/capsule

With the capsules prepared, the treatment may begin with a first Rapid desensitization day 1—RDD1, using dosing (in non-reactive beverage of choice or applesauce or pudding) at 20 minute intervals, as follows.
1 capsule of 1:100,000 (0.003 mg)
2 capsule of 1:100,000 (0.006 mg)
5 capsule of 1:100,000 (0.010 mg)
1 capsule of 1:10,000 (0.030 mg)
2 capsule of 1:10,000 (0.060 mg)

### Week 1—2 Capsule of 1:10,000 (0.060 mg) Each Day

Rapid desensitization day 2 includes the following treatment at intervals.
5 capsule of 1:10,000 (0.10 mg)
1 capsule of 1:1,000 (0.30 mg)
2 capsule of 1:1,000 (0.60 mg)

### Week 2—2 Capsule of 1:1,000 (0.60 mg) Each Day

Rapid desensitization day 3 includes the following treatment at intervals.
5 capsule of 1:1,000 (1.0 mg)
1 capsule of 1:100 (3.0 mg)

After the three rapid desensitization days, the following treatment occurs each week.
Week 3—1 capsule of 1:100 (3.0 mg)
Week 4—2 capsules of 1:100 (6.0 mg)
Week 5—4 capsules of 1:100 (12.0 mg)
Week 6—7 capsule of 1:100 (21.0 mg)
Week 7—1 capsule of 1:10 (30 mg)
Week 8—2 capsules of 1:10 (60 mg)
Week 9—4 capsules of 1:10 (120 mg)
Week 10—7 capsules of 1:10 (210 mg)
Week 11—1 capsule of wheat flour (300 mg)
Week 12—2 capsule of wheat flour (600 mg)
Week 13—3 capsule of wheat flour (900 mg)
Week 14—4 capsule of wheat flour (1200 mg)
Week 15—1 tsp. of wheat flour (1702 mg)
Week 16—1½ tsp. of wheat flour (2553 mg)
Week 17—2 tsp. wheat flour (3404 mg)
Week 18—3 tsp. wheat flour (5105 mg)
Week 19—5 tsp. wheat flour (8509 mg)—oral challenge

After the above treatment steps, the patient will continue a maintenance of about 2½ tsp. of wheat flour or about 4254 mg of wheat protein.

In addition to above, it has been found that the method also successfully treats soy allergies. Instructions for medical food oral immunotherapy method for soy allergy:

For example, the Original Silk® Soy Milk includes 8 gm soy protein in each cup (about 236.6 ml), which is about 0.0338 gm/ml. Other soy types of soy containing beverages may be used. In the specific example with Original Silk Soy Milk, the following was prepared (if other is used, the amounts may change depending on how much soy is in each ml).
1:100—6.6 cc milk into 213.4 cc (220 cc total) distilled water=1 mg/ml
1:1,000—4 cc of 1:100 into 36 cc=0.1 mg/ml

Rapid desensitization day 1—RDD1 with dosing at 20 minute intervals of the following.
0.5 ml of 1:1,000 (0.05 mg)
1 ml of 1:1,000 (0.1 mg)
2 ml of 1:1,000 (0.2 mg each)
4 ml of 1:1,000 (0.4 mg each)
8 ml of 1:1,000 (0.8 mg each)
1 ml of 1:100 (1 mg each)

### Week 1—1 ml of 1:100 (1 mg Each)

Rapid desensitization day 2 with dosing at intervals of the following.
2 ml of 1:100 (2 mg)
3 ml of 1:100 (3 mg)
5 ml of 1:100 (4 mg)

### Week 2 Dosing of 5 ml of 1:100 (5 mg) Each Day.

Rapid desensitization day 3 dosing of the following:
7 ml of 1:100 (7 mg)
0.33 ml soy milk (10 mg)

The following is the treatment protocol after the Rapid desensitization is completed.
Week 3—0.33 ml soy milk (10 mg)
Week 4—0.5 ml soy milk
Week 5—0.7 ml soy milk
Week 6—1.0 ml soy milk
Week 7—1.5 ml soy milk
Week 8—2.0 ml soy milk
Week 9—3 ml soy milk
Week 10—4 ml soy milk
Week 11—6 ml soy milk
Week 12—9 ml soy milk
Week 13—13 ml soy milk
Week 14—20 ml soy milk
Week 15—30 ml soy milk
Week 16—45 ml soy milk
Week 17—65 ml soy milk
Week 18—100 ml soy milk
Week 19—150 ml soy milk
Week 20—240 ml soy milk—oral challenge milk (8 gm)

Ongoing maintenance is performed in the amount of 120 ml (4 gm) per day.

In addition, the method may be used to treat allergies of eggs and milk (as well as either just egg or milk). Instructions for a medical food oral immunotherapy method for egg and milk allergy are as follows. First, obtain some eggs and milk, such as readily available, Eggland's® Best All Whites and Horizon® Organic Whole Milk. The Eggland's Whites contain about 5 gm egg protein per 3 tbsp. (approximately 45 ml), which is about 0.111 gm/ml. The Horizon Organic Whole Milk includes 8 gm milk protein in each cup (about 236.6 ml), which is about 0.0338 gm/ml of milk protein per ml of milk. Of course the amounts may vary, such as if 2% or other brands of milk are used. From this, the following was prepared
Creating the 1:100 mixture by adding 6.6 cc milk and 2 cc egg white into 211.4 cc (220 cc total) of distilled water, creating approximately 1 mg/ml of a first mixture, hereinafter called the “1:100 mixture”
Creating the 1:1,000 mixture by adding—4 cc of the 1:100 mixture into 36 cc of distilled water to create a more diluted 0.1 mg/ml, hereinafter called the “1:1000 mixture”
Creating the 1:10,000 mixture by adding 2 cc of the 1:1,000 mixture into 18 cc of distilled water to create 0.01 mg/ml of allergen per ml, hereinafter the “1:10,000 mixture”. This is followed by the following treatment protocol.

Rapid desensitization day 1—RDD1, with dosing at 20 minute intervals. One can add powdered Kool-Aid, or add it to one of the foregoing treatment foods), and treating the patient according to the following protocol.
1 ml of 1:10,000 (0.01 mg each)
2 ml of 1:10,000 (0.02 mg each)
4 ml of 1:10,000 (0.04 mg each)
8 ml of 1:10,000 (0.08 mg each)
1 ml of 1:1,000 (0.1 mg each)
2 ml of 1:1,000 (0.2 mg each)

### Week 1—2 ml of 1:1,000 (0.2 mg Each)

Rapid desensitization day 2, treating with the following:
4 ml of 1:1,000 (0.4 mg each)
8 ml of 1:1,000 (0.8 mg each)
1 ml of 1:100 (1 mg each)

### Week 2—1 ml of 1:100 (1 mg Each) Each Day

Rapid desensitization day 3, treating with the following:
2 ml of 1:100 (2 mg each)
4 ml of 1:100 (4 mg each)
8 ml of 1:100 (8 mg each)

### Week 3—8 ml of 1:100 (8 mg Each) Each Day

Rapid desensitization day 4 (RDD4) (added optional rapid desensitization day, which was found surprisingly to improve performance), treating with the following:
15 ml of 1:100 (15 mg each)
25 ml of 1:100 (25 mg each)
0.333 ml egg whites, 1.0 ml milk (37 mg egg, 33.8 mg milk)

It is important to note that the RDD4 also includes actual product in addition to the prepared mixtures. The treatment protocol then treats with the following
Week 4—0.333 ml egg whites, 1.0 ml milk
Week 5—0.5 ml egg whites (55.5 mg), 1.5 ml milk (50.7 mg)
Week 6—0.8 ml egg whites (89 mg), 2.25 ml milk (76.1 mg)
Week 7—1.5 ml egg whites (166.5 mg), 3.5 ml milk (118.4 mg)
Week 8—2.25 ml egg whites (250 mg), 5 ml milk (169 mg)
Week 9—3.5 ml egg whites (388.5 mg), 7.5 ml milk (253.6 mg)
Week 10—5 ml egg whites (555 mg), 10 ml milk (338 mg)
Week 11—7.5 ml egg whites (832.5 mg), 15 ml milk (507.2 mg)
Week 12—10 ml egg whites (1.11 gm), 20 ml milk (676 mg)
Week 13—15 ml egg whites (1.665 gm), 30 ml milk (1.014 gm)
Week 14—20 ml egg whites (2.22 gm), 45 ml milk (1.522 gm)
Week 15—30 ml egg whites (3.33 gm), ¼ cup milk (2 gm)
Week 16—45 ml egg whites (4.995 gm), ⅓ cup milk (2.67 gm)
Week 17—75 ml egg whites (oral challenge), ½ cup milk (4 gm)
Week 18—45 ml egg whites, ⅔ cup milk (5.3 gm)
Week 19—45 ml egg whites, ¾ cup milk (6 gm)
Week 20—45 ml egg whites, 1 cup milk (8 gm)
Week 21—45 ml egg whites, 2 cup milk—oral challenge milk

If not treating for both egg and milk substitute the appropriate volume of water for the food not needed.

The present invention can also treat just for an egg allergy using a medical food oral immunotherapy method for egg allergy using whole egg powder, in place of the fresh ingredients as specified in the prior embodiment. Whole egg powder may be obtained from a variety of sources, the example used had 3 gm egg protein/tablespoon of egg powder to make about 15 ml of the food product. Because this was a powder preparation, unlike the prior preparation, the powder was added to capsules for inclusion in the main food product. As with most of the examples, the 00 capsules where prepared and had about 0.9 ml which is about 180 mg whole egg protein.

The following preparations were made into capsules
1:10—2 T flour into 18 T isomalt into capsules=18.0 mg/capsule
1:100—1 T 1:10 into 9 T isomalt into capsules=1.80 mg/capsule
1:1,000—1 T 1:100 into 9 T isomalt into capsules=0.180 mg/capsule
1:10,000—1 T 1:1,000 into 9 T isomalt into capsules=0.0180 mg/capsule
1:100,000—1 T 1:10,000 into 9 T isomalt into capsules=0.00180 mg/capsule

A Rapid desensitization day 1—RDD1 was then completed. The RDD1 was dosed at intervals, included in a medical food.
1 capsule of 1:100,000 (0.00018 mg)
3 capsules of 1:100,000 (0.00054 mg)
8 capsules of 1:100,000 (0.00144 mg)
2 capsule of 1:10,000 (0.0036 mg)
5 capsule of 1:10,000 (0.009 mg)
1 capsule of 1:1,000 (0.18 mg)

### Week 1—1 Capsule of 1:1,000 (0.18 mg) Each Day

Rapid desensitization day 2 with the following given at interval
2 capsule of 1:1,000 (0.36 mg)
5 capsule of 1:1,000 (0.90 mg)
1 capsule of 1:100 (1.8 mg)

### Week 2—1 Capsule of 1:100 (1.8 mg) Each Day

Rapid desensitization day 3 is then accomplished, using the following administered at intervals.
2 capsule of 1:100 (3.6 mg)
5 capsule of 1:100 (9 mg)
1 capsule of 1:10 (18 mg)

Each week, the present invention administers the following.
Week 3—1 capsule of 1:10 (18 mg)
Week 4—2 capsules of 1:10 (36 mg)
Week 5—4 capsules of 1:10 (72 mg)
Week 6—7 capsule of 1:10 (126 mg)
Week 7—1 capsule of whole egg powder (180 mg)
Week 8—2 capsules of whole egg powder (360 mg)
Week 9—4 capsules of whole egg powder (720 mg)
Week 10—7 capsules of whole egg powder (1.26 g)
Week 11—3 tsp. of whole egg powder (3 g)
Week 12—4 tsp. of whole egg powder (4 g)
Week 13—5 tsp. of whole egg powder (5 g)
Week 14—2 tbsp. of whole egg powder (6 g)
Week 15—7 tsp. of whole egg powder (7 g)
Week 16—8 tsp. of whole egg powder (8 g)
Week 17—oral challenge—1 whole egg
Maintenance 2 tbsp. whole egg powder (6 g)

The following are specific protein constituents of the food product, weight of a specific unit such as tablespoon for the flours and calculation method for protein content per volume including the 00 capsules which have a volume of 0.9 cc. As most labels reveal a protein content per weight, a conversation to protein content per volume is required to accurately determine protein content per dose as the doses are measured by volume.

### Almond

6 gm/oz.=28 gm (label), T ave wt=6.162 gm Protein/T=(6/28)6.162=1.32 gm/T 1.32 gm/15 cc, OO cap=. 9 cc, 1.32/(15/0.9)=79.2 mg/cap mg/cap in *tree mix (1 part each nut except 2 parts Macadamia, pecan)=7.92 mg/cap mg/nut=250, maintenance=8 almonds=2 gm

### Brazil Nut

4 gm/oz.=28 gm (label), T has an average weight of 8.9748 gm
Protein/T=(4/28) 8.9748=1.282 gm/T
1.282 gm/15 cc, OO cap=. 9 cc, 1.282/(15/0.9)=76.92 mg/cap
mg/cap in *tree mix=7.69 mg/cap
mg/nut=700, maintenance=1-2 Brazil nuts=. 7-1.4 gm

### Cashew

5 gm/oz.=28 gm (label), T has an average weight of 5.8473 gm
Protein/T=(5/28) 5.8473=1.044 gm/T
1.044 gm/15 cc, OO cap=. 9 cc, 1.044/(15/0.9)=62.64 mg/cap
mg/cap in *tree mix=6.26 mg/cap
mg/nut=250, maintenance=8 cashews=2 gm

### Hazelnut

6 gm/oz.=28 gm (label), T has an average weight of 4.6488 gm
Protein/T=(6/28)4.6488=0.996 gm/T
0.996 gm/15 cc, OO cap=. 9 cc, 0.996/(15/0.9)=59.76 mg/cap
mg/cap in *tree mix=6 mg/cap
mg/nut=200, maintenance=8 hazelnuts=1.6 gm

### Macadamia

2 gm/oz.=28 gm (label), T has an average weight of 8.4032 gm
Protein/T=(2/28) 8.4032=0.6 gm/T
0.6 gm/15 cc, OO cap=. 9 cc, 0.6/(15/0.9)=36.0 mg/cap
mg/cap in *tree mix=7.2 mg/cap
mg/nut=205, maintenance=8 macadamias=1.6 gm

### Pecan

3 gm/oz.=30 gm (label), T has an average weight of 5.7429 gm Protein/T=(3/30) 5.7429=0.574 gm/T 0.574 gm/15 cc, OO cap=. 9 cc, 0.574/(15/0.9)=34.44 mg/cap mg/cap in *tree mix=6.9 mg/cap mg/nut=274, maintenance=7 pecans=1.9 gm

### Pistachio

6 gm/oz.=28 gm (label), T has an average weight of 6.0073 gm
Protein/T=(6/28)6.0073=1.287 gm/T
1.287 gm/15 cc, OO cap=. 9 cc, 1.287/(15/0.9)=77.22 mg/cap
mg/cap in *tree mix=7.72 mg/cap
mg/nut=140, maintenance=10 pistachios=1.4 gm

### Walnut

5 gm/oz.=30 gm (label), T has an average weight of 5.5634 gm
Protein/T=(5/30) 5.5634=0.927 gm/T
0.927 gm/15 cc, OO cap=. 9 cc, 0.927/(15/0.9)=55.62 mg/cap
mg/cap in *tree mix=5.56 mg/cap
mg/nut=616, maintenance=3.5 walnuts=2.16 gm

1. A method of desensitizing a patient to a specific target food allergy using a medical food free of pharmaceutical agents, said method comprising:
preparing a medical food product through the following steps:
providing a food product that is non-reactive for the specific target allergy;
preparing an allergy treatment powder, from a base material that is non-reactive for the specific target allergy and an allergen material, wherein the specific concentration of the allergen material in said allergy treatment is known; and
mixing specified amounts of said allergy treatment powder with said food product to create a plurality of medical food products, each with a different dosage amount;
conducting a first rapid desensitization day (RDD1) through the following steps:
treating the patient through the patient ingesting multiple times and at specified spaced apart time intervals said medical food products and wherein the majority of said medical food ingested at spaced apart intervals has different dosage amounts; and
monitoring the patient for adverse reactions
having the patient ingest said medical food product having a known concentration each day for a first time period;
conducting at the end of the first time period a second rapid desensitization day (RDD2) through the following steps
treating the patient through the patient ingesting multiple times and at specified spaced apart time intervals said medical food products and wherein the majority of said medical food ingested at spaced apart intervals has different dosage amounts; and
monitoring the patient for adverse reactions
having the patient ingest said medical food product having a known concentration each day for a second time period;
continuing treatment of administering said medical food each day using a medical food of specified dosage, and increasing in dosage in the medical food ingested in regular time intervals;
continuing treatment by directly ingesting each day the allergy inducing food for the specific allergy in place of the medical food, and increasing the amounts of allergy inducing food ingested in regular time intervals; and
maintaining an ongoing treatment protocol through ingestion at specified intervals.

2. The method of claim 1 wherein said step of preparing an allergy treatment powder further includes the step of creating multiple allergy treatment powders having different concentrations of said allergen materials.

3. The method of claim 2 wherein said step of creating multiple allergy treatment powders uses serial dilution with a base material that is non-reactive for the specific target food allergy.

4. The method of claim 1 wherein said different dosage amounts during said RDD1 and RDD2 are increasing dosage amounts.

5. The method of claim 4 wherein said last dose on said RDD1 includes at least 100 times more of the specific allergen than said first dose on said RDD1.

6. The method of claim 5 wherein said second dose includes 2-4 times more of the specific allergen than said first dose, and said third includes 5-10 times more, said fourth dose includes 10-30 times more, said fifth dose includes 30-80 times more and said last dose includes at least 100 times more.

7. The method of claim 6 wherein said second dose includes 3 times, said third dose includes 8 times, said fourth dose includes 20 times, said fifth dose includes 50 times and said sixth dose includes 100 times.

8. The method of claim 4 wherein said last dose on said RDD2 includes 3-6 times more of the specific allergen than said first dose on said RDD2.

9. The method of claim 8 wherein said last dose on said RDD2 includes 5 times more allergen than said first dose.

10. The method of claim 9 wherein said first dose on RDD2 includes at least 2 times more allergen than said last dose on said RDD2

11. The method of claim 4 further including a third rapid desensitization day (RDD3).

12. The method of claim 11 wherein said last dose on said RDD3 includes 3-6 times more of the specific allergen than said first dose on said RDD3.

13. The method of claim 11 wherein the interval between said RDD1 and RDD2, and said RDD2 an RDD3 is a week.

14. The method of claim 1 wherein said step of continuing treatment of administering said medical food each day using a medical food of specified dosage lasts for at least five weeks.

15. The method of claim 14 wherein said step of continuing treatment of administering said medical food each day using a medical food of specified dosage lasts for at least eight weeks.

16. The method of claim 14 wherein said step of continuing treatment by directly ingesting each day the allergy inducing food for the specific allergy in place of the medical food, lasts for at least eight weeks.

17. The method of claim 16 wherein said step of continuing treatment by directly ingesting each day the allergy inducing food lasts for at least ten weeks.

18. The method of claim 16 wherein the specific target food allergy is a nut allergy and wherein for at least two weeks following the completion of treatment using a medical food the patient will daily ingest a flour made from the nut and for the remaining weekly period directly ingest at least one nut to which the patient is allergic.

19. The method of claim 1 wherein said step of maintaining an ongoing treatment protocol includes daily ingesting of the specific allergy.

20. A method of desensitizing a patient to a specific target allergy using a medical food free of pharmaceutical agents, said method comprising:
preparing a medical food product through the following steps:
providing a food product that is non-reactive for the specific target allergy;
preparing an allergy treatment powder, from a base material that in non-reactive for the specific target allergy and an allergen material, wherein the specific concentration of the allergen material in said allergy treatment is known; and
mixing specified amounts of said allergy treatment powder with said food product to create a plurality of medical food products, each with a different dosage amount;
conducting a first rapid desensitization day (RDD1) through the following steps:
treating the patient through the patient ingesting multiple times and at specified spaced apart time intervals said medical food products and wherein the majority of said medical food ingested at spaced apart intervals is in increasing dosage amounts; and
monitoring the patient for adverse reactions
having the patient ingest said medical food product having a known concentration each day for a first time period;
conducting a the end of the first time period a second rapid desensitization day (RDD2) through the following steps
treating the patient through the patient ingesting multiple times and at specified spaced apart time intervals said medical food products and wherein the majority of said medical food ingested at spaced apart intervals of increasing dosage amounts; and
monitoring the patient for adverse reactions
having the patient ingest said medical food product having a known concentration each day for a second time period;
continuing treatment of administering said medical food each day using a medical food of specified dosage, and increasing in dosage in the medical food ingested in regular time intervals;
continuing treatment by directly ingesting each day the allergy inducing food for the specific allergy in place of the medical food, and increasing the amounts of allergy inducing food ingested in regular time intervals; and
maintaining an ongoing treatment protocol through ingestion at specified intervals.

21. The method of claim 20 wherein said step of preparing an allergy treatment powder further includes the step of creating multiple allergy treatment powders having different concentrations of said allergen materials using serial dilution with a base material that is non-reactive for the specific target food allergy.

22. The method of claim 20 further including a third rapids desensitization day (RDD3) and wherein said different dosage amounts during said RDD1 and RDD2 are increasing dosage amounts and increasing dosages are also applied during RDD3.

23. The method of claim 22 wherein said second dose includes 3 times, said third dose includes 8 times, said fourth dose includes 20 times, said fifth dose includes 50 times and said sixth dose includes 100 times.

24. The method of claim 22 wherein said last dose on said RDD2 includes 3-6 times more of the specific allergen than said first dose on said RDD2, and said last dose on said RDD3 includes 3-6 times more of the specific allergen than said first dose on said RDD3.

25. The method of claim 20 wherein the interval between said RDD1 and RDD2, and said RDD2 an RDD3 is a week, and wherein said step of continuing treatment of administering said medical food each day using a medical food of specified dosage lasts for at least eight weeks, and said step of continuing treatment by directly ingesting each day the allergy inducing food for the specific allergy in place of the medical food, lasts for at least ten weeks.

26. The method of claim 25 wherein the specific target food allergy is a nut allergy and wherein for at least two weeks following the completion of treatment using a medical food the patient will daily ingest a flour made from the nut and for the remaining weekly period directly ingest at least one nut to which the patient is allergic.

27. The method of claim 1 wherein said step of maintaining an ongoing treatment protocol includes daily ingesting of the specific allergy.

28. A method of desensitizing a patient to a specific target allergy using a medical food free of pharmaceutical agents, said method comprising:
preparing at least six allergy treatment powders through serial dilution the following steps:
preparing a first allergy treatment powder, from a base material that in non-reactive for the specific target allergy and an allergen material, wherein the specific concentration of the allergen material in said allergy treatment is known;
preparing a second allergy treatment powder having a lesser concentration of the allergen material by diluting said first allergy treatment powder with said base material;
preparing a third allergy treatment powder having a lesser concentration of the allergen material than said second allergy treatment powder by diluting said second allergy treatment powder with said base material;
preparing a fourth allergy treatment powder having a lesser concentration of the allergen material than said third allergy treatment powder by diluting said third allergy treatment powder with said base material
preparing a fifth allergy treatment powder having a lesser concentration of the allergen material than said fourth allergy treatment powder by diluting said fourth allergy treatment powder with said base material
preparing a sixth allergy treatment powder having a lesser concentration of the allergen material than said fifth allergy treatment powder by diluting said second allergy treatment powder with said base material;
conducting a first rapid desensitization day (RDD1) through the following steps:
administering a first medical food product prepared by adding a first amount of said sixth allergy treatment powder to a non-reactive food product;
administering a second medical food product 15-60 minutes after said step of administering a first medical food product, and wherein said second medical food product is prepared by adding a second amount of said sixth allergy treatment powder to a non-reactive food product, and wherein said second amount of said sixth allergy treatment powder is greater than said first amount;
administering a third medical food product 15-60 minutes after said step of administering a second medical food product, and wherein said third medical food product is prepared by adding a third amount of said sixth allergy treatment powder to a non-reactive food product, and wherein said third amount of said sixth allergy treatment powder is greater than said first and second amount;
administering a fourth medical food product 15-60 minutes after said step of administering a third medical food product, and wherein said fourth medical food product is prepared by adding a first specified amount of said fifth allergy treatment powder to a non-reactive food product and wherein the total allergen weight in said fourth medical food product is greater than the amount in said first, second and third medical food products;
administering a fifth medical food product 15-60 minutes after said step of administering a fourth medical food product, and wherein said fifth medical food product is prepared by adding a second specified amount of said fifth allergy treatment powder to a non-reactive food product, and wherein said second specified amount of said fifth allergy treatment powder is greater than said first specified amount;
administering a sixth medical food product 15-60 minutes after said step of administering a fifth medical food product, and wherein said sixth medical food product is prepared by adding a first set amount of said fourth allergy treatment powder to a non-reactive food product, and wherein the total allergen weight in said sixth medical food product is greater than the amount in said first, second, third, fourth, and fifth medical food products;
monitoring during each step of administering for any reaction by the patient to the allergen and assessing the amount of reaction to determine if the next step of administering should be performed and only administering the next step when any reaction is within an acceptable reaction
providing the patient with individual daily doses of either said sixth medical food product or said fourth allergy treatment powder for said patient to add to a non-reactive food product to create said sixth medical food product with the proper daily dosage;
conducting a second rapid desensitization day (RDD2), after at least five days of ingesting individual doses using either said sixth medical food product or said fourth allergy treatment powder, with the following steps:
administering a seventh medical food product prepared by adding a first amount of said fourth allergy treatment powder to a non-reactive food product and wherein said seventh medical food product is prepared by adding a second set amount of said fourth allergy treatment powder to a non-reactive food product, and wherein the total allergen weight in said seventh medical food product is greater than the amount in said sixth medical food product, and more than the individual daily doses taken by the patient between said RDD1 and RDD2;
administering an eighth medical food product 15-60 minutes after said step of administering a seventh medical food product, and wherein said eighth medical food product is prepared by adding a third set amount of said fourth allergy treatment powder to a non-reactive food product, and wherein the total allergen weight in said eighth medical food product is greater than the amount in said seventh medical food product;
administering a ninth medical food product 15-60 minutes after said step of administering an eighth medical food product, and wherein said ninth medical food product is prepared by adding a measured amount of said third allergy treatment powder to a non-reactive food product and wherein said ninth medical food product includes more allergen material than said first through eighth medical food products
providing the patient with individual daily doses of either said ninth medical food product or individual doses of said third allergy treatment powder used to create said ninth medical food product, for said patient to add to a non-reactive food product to create said ninth medical food product with the proper daily dosage;
conducting a third rapid desensitization day (RDD3), after at least five days of ingesting individual doses using either said sixth medical food product or said fourth allergy treatment powder, with the following steps:
administering a tenth medical food product prepared by adding a second measured amount of said third allergy treatment powder to a non-reactive food product and wherein the total allergen weight in said tenth medical food product is greater than the amount in said first through ninth medical food product, and more than the individual daily doses taken by the patient between said RDD1 and RDD2, as well as between RDD2 and RDD3;
administering an eleventh medical food product 15-60 minutes after said step of administering a tenth medical food product, and wherein said eleventh medical food product is prepared by adding a third measured amount of said third allergy treatment powder to a non-reactive food product, and wherein the total allergen weight in said eleventh medical food product is greater than the amount in said tenth medical food product;
administering a twelfth medical food product 15-60 minutes after said step of administering an eleventh medical food product, and wherein said twelfth medical food product is prepared by adding a measured amount of said second allergy treatment powder to a non-reactive food product and wherein said twelfth medical food product includes more allergen material than said first through eleventh medical food products;
monitoring during each step of administering for any reaction by the patient to the allergen and assessing the amount of reaction to determine if the next step of administering should be performed and only administering the next step when any reaction is within an acceptable reaction
providing the patient with individual daily doses which contain either said first and said second allergy treatment powder and wherein said daily doses increase every dosage period, which is five to twelve days, and wherein in each dosage period the amount of allergen included in the daily dosage increases as compared to the prior dosage period;
providing a remaining treatment protocol for additional dosage periods, with each dosage period including increasing amounts of allergen and wherein the patient during this remaining treatment protocol will directly intake the allergy material and not the allergy treatment powder
having the patient complete an oral challenge and upon successfully completing the oral challenge perform ongoing maintenance by daily ingesting the target food allergen.

29. The method of claim 28 wherein said dry powder mixtures are made through serial dilution with each successive dilution including only 10% of the allergen in the prior material

30. The method of claim 28 wherein the base material is isomalt.

31. The method of claim 28 wherein the target allergy is one of a peanut, hazelnuts, walnuts, pecans, cashews, pistachios, macadamias, or brazil nut.

32. The method of claim 28 wherein the allergen material includes a specific allergy protein wherein the specific allergy protein is provided in a known concentration.

33. The method of claim 28 wherein said allergy treatment powder is divided into specific capsules.
